(19) United States
(12) Patent Application Publication
(10) Pub. No.: US 2023/0350708 A1
(43) Pub. Date: Nov. 2, 2023

(54) DYNAMIC ON-DEMAND DATACENTER CREATION

(71) Applicant: Microsoft Technology Licensing, LLC, Redmond, WA (US)

(72) Inventors: Sagiv DRAZNIN, Walnut Creek, CA (US); Arun BHAMIDIMARRI, North Brunswick, NJ (US)

(73) Assignee: Microsoft Technology Licensing, LLC, Redmond, WA (US)

(21) Appl. No.: 17/732,050

(22) Filed: Apr. 28, 2022

(51) Int. Cl. G06F 9/455; G06F 11/34

(52) U.S. Cl. CPC G06F 9/45558; G06F 11/3495; G06F 2009/45562; G06F 2009/4557; G06F 2009/45595

(57) ABSTRACT

A system for dynamically creating datacenters is provided, which creates on-demand datacenters where and when they are needed by federating the memory and processing power of subscribing devices into “cloudlets.” A cloudlet may serve as an on-demand datacenter, based on the combined storage, memory, and compute resources of a plurality of federated computing devices, for processing workloads of tenants in proximity to the cloudlet. Depending on the combination of federated devices, cloudlets may provide different levels of on-demand computing resources to a variety of applications. Due to proximity of the datacenter to the demand, latency is reduced; and due to combined computing power of multiple distributed devices, demand can be met with a smaller physical footprint and reduced energy requirements.

### BACKGROUND

Cloud computing systems require large-scale, large-footprint facilities with massive compute, storage, and networking resources. More recently, multi-access Edge Computing (MEC) has become important to improve the performance of cloud services. MEC brings applications from these centralized datacenters to the network edge, closer to end users. While near- and far-edge systems improve the geographic proximity of computing resources, these systems are still constrained by physical and geographic boundaries - which may or may not be near the applications needing cloud resources. Moreover, these near- and far-edge systems may not be able to meet dynamic demand in a particular geographic area. This may cause issues for latency-sensitive applications, such as autonomous vehicle technologies, remote surgical procedures, and the like.

It is with respect to these and other general considerations that embodiments have been described. Also, although relatively specific problems have been discussed, it should be understood that the disclosed embodiments should not be limited to solving the specific problems identified in the background.

### SUMMARY

Aspects of the present disclosure are directed to dynamically creating proximate, opportunity-driven datacenters.

In an aspect, a method for dynamically creating a datacenter in geographic proximity to one or more applications is provided. The method includes receiving an indication of a contribution of computing resources from each of a plurality of computing devices in proximity to a geographic area and, based on the contribution of computing resources, the method further includes determining a device ranking for each computing device of the plurality of computing devices. Based on the device ranking for each computing device, the method also includes determining that a subset of the plurality of computing devices meets at least one condition for dynamically creating the datacenter in proximity to the geographic area. Additionally, the method includes federating the subset of computing devices to dynamically create the datacenter in proximity to the geographic area, where the datacenter includes shared computing resources of the federated subset of computing devices. Further, based on the device rankings of the federated subset of computing devices, the method includes assigning a datacenter ranking to the datacenter and, based on the datacenter ranking, deploying one or more workloads of the one or more applications onto the shared computing resources of the datacenter.

In another aspect, a system for dynamically creating a cloudlet in geographic proximity to one or more applications is provided. The system includes computer-executable instructions that when executed by a processor cause the system to perform operations. The operations include receiving an indication of a contribution of computing resources from each of a plurality of computing devices in proximity to a geographic area and, based on the contribution of computing resources, determining a device ranking for each computing device of the plurality of computing devices. Based on the device ranking of each computing device, the operations further include determining that a subset of the plurality of computing devices meets at least one condition for dynamically creating the cloudlet in proximity to the geographic area, where the cloudlet is a proximate datacenter to the geographic area. Additionally, the operations include federating the subset of computing devices to dynamically create the cloudlet in proximity to the geographic area, where the cloudlet includes shared computing resources of the federated subset of computing devices. Based on the device rankings of the federated subset of computing devices, the operations include assigning a cloudlet ranking to the cloudlet and, based on the cloudlet ranking, deploying one or more workloads of the one or more applications onto the shared computing resources of the cloudlet. Further, the operations include monitoring a performance of each computing device of the federated subset of computing devices and, in response to determining that a first performance of a first computing device of the federated subset of computing devices falls below a threshold, the operations include automatically migrating at least a portion of the one or more deployed workloads onto unused computing resources of a second computing device of the federated subset of computing devices.

In yet another aspect, a system for dynamically creating a datacenter in geographic proximity to one or more applications is provided. The system includes computer-executable instructions that when executed by a processor cause the system to perform operations. The operations include receiving an indication of a contribution of computing resources from each of a plurality of computing devices in proximity to a geographic area and, based on the contribution of computing resources, determining a device ranking for each computing device of the plurality of computing devices. Based on the device ranking for each computing device, the operations include determining that a subset of the plurality of computing devices meets at least one condition for dynamically creating the datacenter in proximity to the geographic area. Additionally, the operations include federating the subset of computing devices to dynamically create the datacenter in proximity to the geographic area, where the datacenter comprises shared computing resources of the federated subset of computing devices. Based on the device rankings of the federated subset of computing devices, the operations include assigning a datacenter ranking to the datacenter and, based on the datacenter ranking, deploying one or more workloads of the one or more applications onto the shared computing resources of the datacenter. Further, the operations include monitoring a performance of the datacenter. In response to determining that the datacenter performance is insufficient to process the one or more deployed workloads, the operations include determining that at least one datacenter is available in proximity to the geographic area and automatically migrating the one or more deployed workloads to the at least one available datacenter in proximity to the geographic area.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 shows a block diagram of a first network configuration, according to an example aspect.

FIG. 2 shows a block diagram of a second network configuration, according to an example aspect.

FIG. 3 is a block diagram illustrating example physical components of computing devices with which aspects of the disclosure may be practiced.

FIG. 4 shows a block diagram of an example timeline associated with dynamically creating and/or vacating on-demand datacenters, according to an example embodiment.

FIG. 5 show a flowchart of an example method for dynamically creating a proximate, on-demand datacenter, according to an example embodiment.

FIG. 6 shows a flowchart of an example method for orchestrating workloads on on-demand datacenters, according to an example embodiment.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present disclosure relate to dynamically creating “ad-hoc” datacenters in any proximate geographic location at any time to meet dynamic computing demand while also having a minimal physical footprint with geographic proximity to demand. As mentioned above, cloud computing systems require large-scale, large-footprint facilities with massive compute, storage, and networking resources. While near- and far-edge systems improve the geographic proximity of computing resources, these systems are still constrained by physical and geographic boundaries - which may or may not be near the applications needing cloud resources. Proximity to datacenters is important to reduce processing latency, particularly for latency-sensitive applications (e.g., autonomous vehicle technologies, remote surgical procedures, and the like).

To overcome the physical and geographic constraints of the cloud infrastructure, the present application describes a system of dynamically creating datacenters where and when they are needed by federating the memory and processing power of subscribing devices into “cloudlets.” These cloudlets can be dynamically created and destroyed based on availability of nearby subscribing devices. A subscribing device may be “turned on” or made available to the system when a user agrees to make portions of the storage, memory, and processing resources of the device available to the service. In aspects, the user may be compensated accordingly for the amounts of time and resources contributed to the service. In examples, a cloudlet may serve as an on-demand datacenter (including combined storage, memory, and compute resources of a plurality of federated computing devices) for processing workloads of tenants in proximity to the cloudlet. Depending on the combination of federated devices, cloudlets may provide different levels of on-demand computing resources to a variety of applications. Due to proximity of the datacenter to the demand, latency is reduced; and due to combined computing power of multiple distributed devices, demand can be met with a smaller physical footprint and reduced energy requirements.

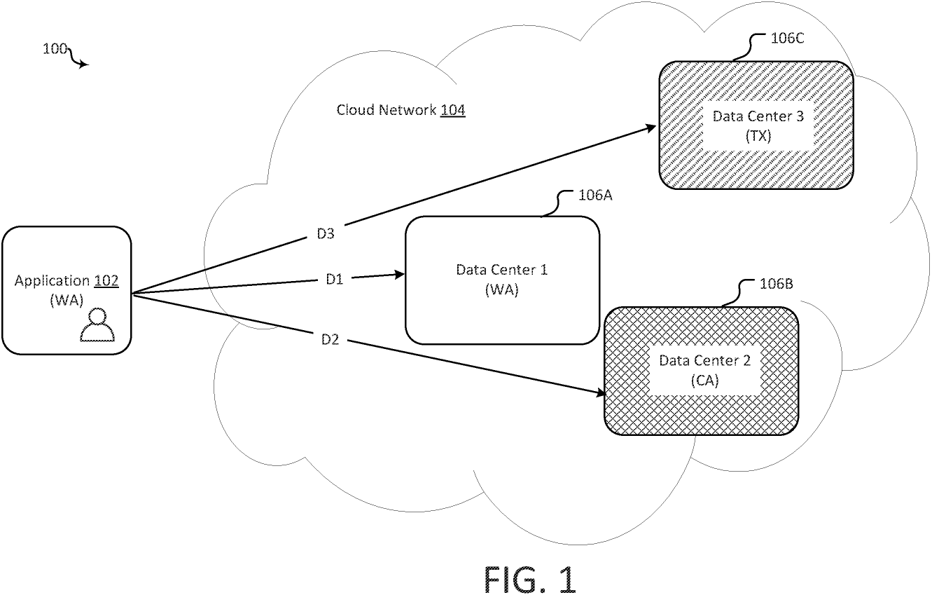

This and many further embodiments for dynamically creating proximate, on-demand datacenters are described herein. FIG. 1 shows a block diagram of a first network configuration 100, according to an example aspect. For instance, the first network configuration 100 may comprise an application 102 located in Washington State requesting computing resources from one or more datacenters 106 in a cloud network 104. As illustrated, the first network configuration 100 includes datacenter 106A (located in Washington State), a datacenter 106B (located in California), and a datacenter 106C (located in Texas). In aspects, datacenters 106 may be large-scale, large-footprint facilities with massive compute, storage, and networking resources located in different regions of the U.S. (e.g., Washington, California, Texas) or abroad (not shown). In some cases, datacenter 106A (located in Washington State) may be a near- or far-edge system to improve the geographic proximity of computing resources in Washington State. However, datacenter 106A may still be constrained by both geographic boundaries, which may or may not be near application 102, and physical boundaries within Washington State, which may prevent datacenter 106A from dynamically meeting demand in the geographic area.

As noted above, application proximity to datacenters 106 is important to reduce latencies associated with uploading, downloading, storing and/or processing data of application workloads for tenants of a public cloud service. That is, the further away a datacenter is from the application requesting resources, the longer it takes to communicate with the datacenter over the network and process the workload. As illustrated, datacenter 106A is at distance D1, datacenter 106B is at distance D2, and datacenter 106C is at distance D3 from the application 102. In some examples, distance D3 may be greater than distance D2, which may be greater than distance D1. Thus, in some examples, application 102 may experience some latency in processing workloads on datacenter 106A, additional latency in processing workloads on datacenter 106B, and still further latency in processing workloads on datacenter 106C.

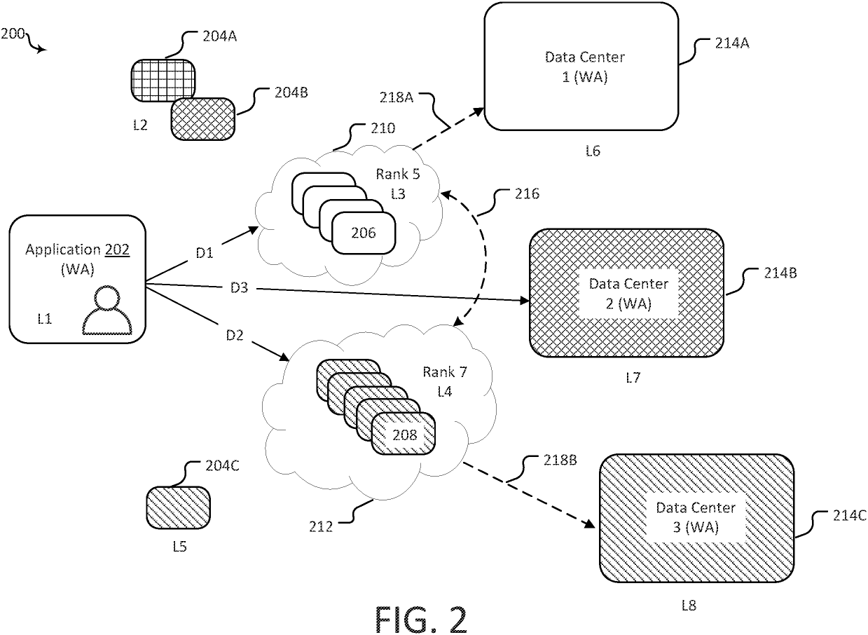

In contrast, FIG. 2 shows a block diagram of a second network configuration 200, according to an example aspect. Similar to first network configuration 100, the second network configuration 200 may include an application 202 at a location L1 in Washington State. However, in addition to datacenter 214B, this configuration enables application 202 to utilize computing resources on a first cloudlet 210 and/or a second cloudlet 212. As described further below, a cloudlet may be dynamically created by federating available subscribing devices within a geographic proximity. A device may include any computing device having available processing power and memory that is able to connect to a network. For example, devices may include mobile phones, tablets, laptops, personal computers, Internet-of-Things (IoT) devices, gaming consoles, servers, and the like. The system may be based on a client-server architecture in which a lightweight applet (e.g., application) installed on the subscribing devices communicates with a cloudlet manager residing in a public cloud infrastructure.

In aspects, once installed, the applet (e.g., application) is passive and allows only control plane messages between two state machines. The applet is configured to partition off unavailable (e.g., utilized) device processing and/or memory resources and may only access unused and available resources. In some aspects, a user-configurable portion of the unused resources may be designated as available (e.g., 10%-90%), but in some cases the system may require a minimum amount of available storage (e.g., 1 GB, 10 GB, 50 GB, 100 GB, or the like). Additionally, the system may require the unused resources to be made available for a guaranteed period of time (e.g., 60 minutes, 90 minutes, 120 minutes, or the like). In addition to partitioning off unavailable resources, the applet may further be excluded from accessing any sensitive, personal-identifiable or device-identifiable information, such as user name, phone number, physical address, IP address, device ID, passwords, credit card information, and the like. Rather, a randomized registration ID may be assigned when a device is registered with the system. In this way, federated devices within a cloudlet have no knowledge or discoverability of one another. In aspects, when devices are federated in a cloudlet, the contributed resources of each device may be combined and scheduling workloads on the combined resources may be controlled by a cloudlet manager.

In examples, upon opening the applet on a device, the applet will receive and/or assess the available device resources, e.g., memory and compute power. In some cases, a user interface associated with the applet may present selectable options for contributing an amount of unused storage. For example, the user may contribute (or allocate) a configurable percentage of unused storage (e.g., 10% - 90%) or an explicit amount of unused storage (e.g., 100 GB, 200 GB, 500 GB). In some cases, as noted above, the service may require a minimum amount of available storage for a device to participate (e.g., 1 GB, 10 GB, 50 GB, 100 GB, etc.), in which case the user interface may not present options for donating less than the minimum amount. Once the applet receives an amount of available storage, the applet may assess compute and other resources of the device and may assign a device ranking. According to alternative embodiments, the cloudlet manager may assess compute and other resources of the device and may assign a device ranking. The device ranking may be based on one or more of: available storage, processing unit speed, available processing cores and threads, random access memory (RAM), network stability, device type, device mobility, or the like. For instance, the device may be given a device ranking between “1” (lowest) to “5” (highest).

A device with a ranking of “1” may be an IoT device or a mobile device with lighter resources, lower network stability, and/or higher mobility. That is, while mobile devices may be stationary most of the time (e.g., on a desk at work, on a nightstand overnight, in a purse over lunch, etc.), the system must still account for the probability that these devices will be portable at least some of the time. Moreover, even when mobile devices are stationary, network reliability may be lower based on the strength of the cellular network or the availability of WiFi at the stationary location (e.g., in an office building, coffee shop, or at home). Not only are these “thin devices” configured with lighter compute and memory resources, the resources may be more heavily utilized. For instance, the memory of IoT and mobile devices may store numerous heavy files, such as images, videos, sensor data, etc., and these devices may be continuously processing incoming/outgoing data throughout the day (e.g., texts, phone calls, sensor data, signal processing, etc.). As a result, the device ranking of a mobile device may change based on time of day, with a lower device ranking during peak times such as morning, noon, early evening (e.g., based on higher mobility, lower network stability, and higher memory and compute usage) and a higher device ranking late at night or early in the morning (e.g., based on lower mobility, higher in-home network stability, and lower memory and compute usage). In some cases, users may be incentivized to make mobile devices available during non-peak hours based on higher compensation.

In contrast, devices with high stability and heavy resource availability may receive higher device rankings, e.g., “4” or “5.” These devices may be personal desktop computers, gaming consoles, or servers, for instance, which are generally stationary, have higher compute and memory availability, and higher network stability (e.g., home or office WiFi networks). As with mobile and IoT devices, rankings for these devices may change based on the time of day, with lower device rankings during heavy compute and memory usage (e.g., during the workday, during evenings due to streaming and gaming, etc.) and higher device rankings late at night and early in the morning. Continuing with the spectrum of devices, laptop or tablet computers may be ranked at “2” or “3,” for instance, based on higher compute and memory resources than mobile devices, but with some likelihood of mobility and network instability. As with the other devices, device rankings for laptops and tablets may also change during the day.

In addition to assigning a rank to the device, the applet may communicate a general location of the device to the cloudlet manager. In aspects, the general location is not a precise location, such as a GPS location, but a general vicinity such as a neighborhood (e.g., Jackson Heights), an area of a city (e.g., downtown, south suburban), an attraction (e.g., Fisherman’s Wharf, Disneyland®), and the like. Once the applet communicates the resource information (e.g., memory allocation and compute power rank) and the general location, the device is registered and becomes available to the cloudlet manager. The cloudlet manager may then identify other registered devices that are proximate to or “nearby” the general location. For instance, a proximate location may be a subset of the general location, e.g., Jackson Heights may be a proximate location within the general location of lower downtown. Additionally or alternatively, the proximate location may be less than a maximum distance from the general location, e.g., less than 2 square miles, 5 square miles, 10 square miles, or the like.

According to some aspects, the cloudlet manager may federate proximate devices with a variety of device rankings. In this way, the lower rankings of some devices may be offset by the higher rankings of other devices, making the overall cloudlet more stable. For instance, a rule may specify that at least one device must be stationary (e.g., personal computer, game console, or server) to serve as an anchor for the cloudlet. Rules may also specify a threshold number of devices required to create a cloudlet, e.g., 4 or 5 devices, and/or a threshold amount of combined memory and/or compute power required to create a cloudlet. In some aspects, once a first threshold is reached, whether a number of devices or a combined amount of memory/compute, a first cloudlet may be created and subsequent registered devices may be reserved to meet a second threshold for creating a second cloudlet. In this way, cloudlets are continuously formed and made available to dynamically meet demand. In other aspects, subsequent registered devices may be added to an existing cloudlet. In this way, existing cloudlets may be enlarged to dynamically meet specific requirements or heavy demand, or an existing cloudlet may be maintained by dynamically replacing expiring or unstable devices. Moreover, based on the proximate locations of federated devices, cloudlets may provide computing resources much closer to the demand than traditional cloud computing configurations, whether regional datacenters or near- and far-edge datacenters, thereby reducing latencies associated with processing application workloads.

Based on the number and rankings of the federated devices, the cloudlet manager may then calculate a cloudlet ranking from “1” (e.g., for a small-size cloudlet), which may be suitable for light-weight applications and workloads, to “10” (e.g., for a large-size cloudlet), which may be suitable for applications needing heavy processing and memory resources. Additionally, based on the guaranteed availability period of each device, the cloudlet manager may further calculate a cloudlet lifetime, which may depend on the time from the last device added until the expiration time of the first guaranteed time period. In aspects, a cloudlet having a shorter lifetime may be suitable for processing small, finite jobs; whereas a cloudlet having a longer lifetime may be suitable for multi-stage processing jobs. It should be appreciated that the cloudlet lifetime may be extended by federating comparable new devices before existing devices expire. Additionally or alternatively, devices having the same or similar guaranteed availability may be federated, allowing the cloudlet to be vacated at or about the time all devices will expire.

Returning to FIG. 2, application 202 at location L1 is a distance D1 from first cloudlet 210 at location L3, a distance D2 from second cloudlet 212 at location L4, and a distance D3 from datacenter 214B at location L7. In examples, distance D1 is less than distance D2, which is less than D3. In further examples, location L3 at distance D1 and location L4 at distance D2 may be in the same or similar general location as application 202 at location L1 (e.g., downtown Seattle), whereas location L7 at distance D3 may be outside of the general location (e.g., Bellevue, Washington). In some cases, datacenter 214B may be a near- or far-edge system, with improved geographic proximity over regional datacenters; however, datacenter 214B may still be further away from application 202 than first cloudlet 210 or second cloudlet 212.

As illustrated, first cloudlet 210 includes four federated devices 206 and second cloudlet 212 includes five federated devices 208. As detailed above, federated devices 206 may be associated with a spectrum of device rankings. In aspects, the number of federated devices (four) and the individual rankings of the federated devices 206 may be used to calculate the cloudlet ranking of “5” for first cloudlet 210. Similarly, the number of federated devices (five) and the individual rankings of the federated devices 208 may be used to calculate the cloudlet ranking of “7” for second cloudlet 212. As illustrated, the first cloudlet 210 is represented as a smaller cloudlet than second cloudlet 212. As should be appreciated, first cloudlet 210 may be suitable for processing lighter-weight workloads, whereas second cloudlet 212 may be suitable for processing heavier-weight workloads. Further illustrated are devices 204A-204B at location L2 and device 204C at location L5. In aspects, devices 204A-204C may be registered devices that are available to the cloudlet manager. As additional registered devices become available at locations L2 and L5, the cloudlet manager may federate these registered devices into cloudlets at locations L2 and L5.

By combining the memory and compute resources of the federated devices, a cloudlet can offer substantial storage as well as a number of virtual CPUs (vCPUs) for processing different workloads or for parallel processing a single workload. However, in some cases, a cloudlet may become unstable or may even fail. This may occur for various reasons, including one or more federated devices expiring, becoming unstable, or failing. For instance, a federated device may expire when the guaranteed availability period expires or a federated device may become unstable with increased mobility, which may result in connection interruptions when the device passes from one network to another (e.g., from one cellular network to another, cellular to/from WiFi), enters areas with weak cellular network signals (e.g., a concrete office building), or the like. Additionally, even stationary federated devices may experience network instability, e.g., due to router or modem failures, weather-related issues, spikes in network traffic, or the like. Not only so, but federated devices may experience operating system failures, driver failures, processor failures, memory failures, and the like. In aspects, a portion of the combined resources of a cloudlet may be reserved for failovers. In this case, the cloudlet manager may migrate workloads off an unstable device, while continuing to monitor the device. If the device remains unstable, the device may be defederated from the cloudlet. To maintain the cloudlet ranking, the cloudlet manager may identify one or more comparable registered devices in the general location to add to the cloudlet.

Indeed, the cloudlet manager may continuously monitor fluctuations in device rankings within a cloudlet to maintain the cloudlet ranking in the geographic location. The cloudlet manager may further monitor cloudlet remaining lifetime, performance, resource usage, power usage, etc., and when a cloudlet becomes unstable, the cloudlet manager may identify one or more nearby cloudlets with capacity for handling workloads processing on the unstable cloudlet. When an available nearby cloudlet is identified, the cloudlet manager may migrate workloads from the unstable cloudlet to the available nearby cloudlet. For example, as illustrated by failover path 216 of FIG. 2, if first cloudlet 210 becomes unstable, workloads may be migrated to nearby second cloudlet 212. Similarly, if second cloudlet 212 becomes unstable, workloads may be migrated to nearby first cloudlet 210. Since first cloudlet 210 has a lower rank than second cloudlet 212, a portion of the workloads processing on second cloudlet 212 may be migrated to first cloudlet 210, while remaining workloads may be migrated to another nearby cloudlet and/or a datacenter, for instance. In aspects, the cloudlet manager may act as a dispatcher, where workloads may be scheduled on the closest cloudlet to the demand and then dynamically migrated to other nearby cloudlets as necessary.

When an available nearby cloudlet is not identified, the cloudlet manager may migrate workloads from the unstable cloudlet to a public cloud datacenter. As illustrated, if first cloudlet 210 becomes unstable and nearby second cloudlet 212 is unavailable, workloads may be offloaded to datacenter 214A, as illustrated by failover path 218A. Similarly, if second cloudlet 212 becomes unstable and nearby first cloudlet 210 is unavailable, workloads may be offloaded to datacenter 214C, as illustrated by failover path 218B. In aspects, the cloudlet manager may reserve resources on cloud datacenters 214A-214C to facilitate seamless failover. In this case, while datacenters 214A-214C are farther away from application 202, the system may reduce failover latencies when necessary.

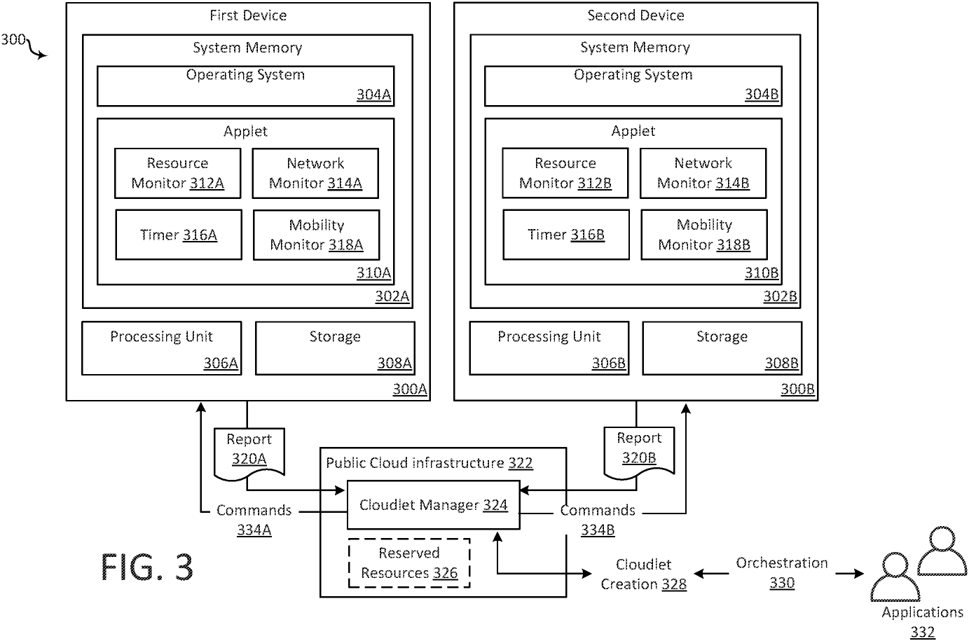

FIG. 3 is a block diagram illustrating example physical components of computing devices with which aspects of the disclosure may be practiced.

As illustrated, system 300 includes a first computing device 300A, a second computing device 300B, a public-cloud infrastructure 322, and applications 332. In a basic configuration, the first computing device 300A and the second computing device 300B may include at least one processing unit 306A-B and a system memory 302A-B, respectively. Depending on the configuration and type of computing device, the system memory 302A-B may comprise, but is not limited to, volatile storage (e.g., random access memory), non-volatile storage (e.g., read-only memory), flash memory, or any combination of such memories. The system memory 302A-B may include an operating system 304A-B and at least one application, such as applet 310A-B. The operating system 304A-B, for example, may be suitable for controlling the operation of the first and second computing devices 300A-B, respectively. The first and second computing devices 300A-B may have additional features or functionality. For example, the first and second computing devices 300A-B may also include additional data storage 308A-B, respectively.

As stated above, applet 310A-B may be stored in the system memory 302A-B of first and second computing devices 300A-B, respectively. While executing on the at least one processing unit 306A-B, the applet 310A-B may perform processes including, but not limited to, the aspects, as described herein. The applet 310A-B includes a resource monitor 312A-B, a network monitor 314A-B, a timer 316A-B, and a mobility monitor 318A-B. In aspects, resource monitor 312A-B may assess and monitor computing resources of the first and second computing devices 300A-B, such as system memory 302A-B, processing unit 306A-B, and/or storage 308A-B, respectively. Resource monitor 312A-B may assess amount of unused, available memory, processing, and storage resources of the first and second computing devices 300A-B, respectively, and may compile the amount for inclusion in report 320A-B. In aspects, the amounts of available memory, processing, and storage resources may be different for first computing device 300A and second computing device 300B. For instance, first computing device 300A may be a mobile device comprising 200 GB of available, unused storage, an 8-core, 16-thread, 1.7-2.8 GHz processor, and 4 GB of random-access memory (RAM); whereas second computing device 300B may be a personal computer (PC) comprising 1 TB of available, unused storage, a 64-core, 128 thread, 2.9-4.3 GHz processor, and 16 GB of RAM. In some cases, resource monitor 312A-B may partition such resources from used resources of the first and second computing devices 300A-B. As applet 310A-B schedules application workloads on the first and second computing devices 300A-B, respectively, resource monitor 312A-B may continuously monitor the computing resources for utilization, instability, and/or failures.

Network monitor 314A-B of applet 310A-B may continuously monitor a network connection of the first and second computing devices 300A-B, respectively, and a stability of the network. Network monitor 314A-B may further monitor a connection transition from one network to another of first and second computing devices 300A-B. In aspects, the network connection may be associated with an ability of first and second computing devices 300A-B to connect to a network based on hardware and/or software components of the first and second computing devices 300A-B, such as radio frequency (RF) transmitter, receiver, and/or transceiver circuitry; universal serial bus (USB), parallel and/or serial ports, network cards, drivers, and the like. The stability of the network may be associated with the operation of hardware and/or software associated with the network, such as routers, switches, modems, transceivers, etc., and/or a strength or weakness of a network signal broadcast from a cell tower, for instance. When network monitor 314A-B detects instability in the network connection and/or the network, network monitor 314A-B may report such instability to applet 310A-B for inclusion in report 320A-B. As applet 310A-B schedules application workloads on the first and second computing devices 300A-B, respectively, network monitor 314A-B may continuously monitor the network connection and the network associated with first and second computing devices 300A-B, respectively, for instability. As should be appreciated, the network connection and stability of the first computing device 300A may be different than the network connection and stability of the second computing device 300B. For instance, in an example, the network connection and stability of the first computing device 300A (mobile device) may be weaker than the network connection and stability of second computing device 300B (PC).

In further aspects, timer 316A-B of applet 310A-B may count down a guaranteed availability period of unused computing resources associated with first and second computing devices 300A-B, respectively. As such be appreciated, a start time of the guaranteed availability period and/or a length of the guaranteed availability period may be different between first and second computing devices 300A-B. Timer 316A-B may report such countdown to applet 310A-B for inclusion in report 320A-B.

Mobility monitor 318A-B of applet 310A-B may detect a general location and monitor a movement of first and second computing devices 300A-B, respectively. For instance, mobility monitor 318A-B may detect a position of the first and second computing devices 300A-B, respectively, based on monitoring sensors (e.g., global positioning system (GPS) sensor, proximity sensor, position sensor, etc.) and may translate the position into a general location (e.g., based on mapping software, or the like). As noted above, a general location may refer to a neighborhood, area of a city, proximity to an attraction, or the like. As should be appreciated, first computing device 300A may be at a first position and second computing device 300B may be at a second position. In some cases, the first position and the second position may be associated with the same general location (e.g., downtown Seattle); in other cases, the first position may be associated with a first general location (e.g., downtown Seattle) and the second position may be associated with a second general location (e.g., downtown Bellevue).

To detect movement, mobility monitor 318A-B may monitor the same or additional sensors associated with first and second computing devices 300A-B, such as an accelerometer, gyroscope, magnetometer, GPS sensor, or the like. When mobility monitor 318A-B detects a general location and/or a change in mobility, either an increase or a decrease in movement, mobility monitor 318A-B may report such general location and/or movement to applet 310A-B for inclusion in report 320A-B. As should be appreciated, first computing device 300A (mobile device) may be stationary much of the time but may exhibit at least some movement, whereas second computing device 300B (PC) may rarely if ever exhibit movement. As applet 310A-B schedules application workloads on the first and second computing devices 300A-B, respectively, mobility monitor 314A-B may continuously monitor the first and second computing devices 300A-B, respectively, for a general location and/or changes in movement.

Applet 310A-B may continuously or periodically send report 320A-B to a cloudlet manager 324 residing on public cloud infrastructure 322. In aspects, report 320A-B may be sent continuously on a predetermined schedule, e.g., every millisecond, every second, etc., or report 320A-B may be sent periodically whenever a change is detected, for instance, by resource monitor 312A-B, network monitor 314A-B, timer 316A-B, and/or mobility monitor 318A-B, respectively.

System 300 further includes cloudlet manager 324. In aspects, cloudlet manager 324 may receive report 320A from applet 310A for first computing device 300A and may determine a device ranking for first computing device 300A. In aspects, the device ranking may be based on one or more of: available storage, processing unit speed, available processing cores and/or threads, random access memory (RAM), network stability, device type, device mobility, or the like. For instance, the device may be given a device ranking between “1” (lowest) to “5” (highest). Based on the examples above, first computing device 300A is a mobile device comprising 200 GB of available, unused storage, an 8-core, 16-thread, 1.7-2.8 GHz processor, and 4 GB of random-access memory (RAM). The first computing device 300A may transiently connect to cellular and/or WiFi networks, which networks may have varying signal strength and/or stability. Moreover, first computing device 300A may be associated with at least some mobility or movement. In this case, the cloudlet manager may assign the first computing device 300A with a device ranking of “1.” In contrast, second computing device 300B is a PC comprising 1 TB of available, unused storage, a 64-core, 128 thread, 2.9-4.3 GHz processor, and 16 GB of RAM. The second computing device 300B may consistently connect to a wired or wireless local WAN network, which may have relatively consistent signal strength and/or stability. Moreover, second computing device 300A may be associated with little or no movement. In this case, the cloudlet manager may assign the second computing device 300B with a device ranking of “4.”

Cloudlet manager 324 may further retrieve the general locations of first and second computing devices 300A-B, respectively, from report 320A-B. In an example, while the positions of the first and second computing devices 300A-B may be different, the first and second computing devices 300A-B may be in the same general location (e.g., downtown Seattle). In this case, cloudlet manager 324 may determine whether to federate first and second computing devices 300A-B to create a cloudlet or add the first and/or second computing device 300A-B to an existing cloudlet. Cloudlet manager 324 may consult one or more rules to determine whether to federate first and second computing devices 300A-B into a new or existing cloudlet. For example, rules may require that each cloudlet includes at least one stationary device, each cloudlet comprises a minimum number of devices, each cloudlet comprises devices in the same general location, and/or that each cloudlet comprises a minimum amount of computing resources (e.g., storage and compute power). In the present example, since second computing device 300B is a stationary device (PC) and the first and second computing devices 300A-B are in the same general location, cloudlet manager 324 may determine that a new cloudlet may be created 328. In this case, cloudlet manager 324 may federate the first and second computing devices 300A-B to create 328 the new cloudlet.

In further aspects, additional devices (not shown) may be added to the new cloudlet to include the minimum number of devices and/or the minimum computing resources based on one or more rules. Based on the number and rankings of the federated devices (e.g., first and second computing devices 300A-B), the cloudlet manager 324 may then calculate a cloudlet ranking from “1” (e.g., for a small-size cloudlet), which may be suitable for light-weight applications and workloads, to “10” (e.g., for a large-size cloudlet), which may be suitable for applications needing heavy processing and memory resources. Additionally, based on the guaranteed availability period of each federated device (e.g., first and second computing devices 300A-B), the cloudlet manager may further calculate a cloudlet lifetime, which may depend on the time from the last device added until the expiration time of the first guaranteed time period. In aspects, a cloudlet having a shorter lifetime may be suitable for processing simple, finite jobs; whereas a cloudlet having a longer lifetime may be suitable for complex, multi-stage processing jobs.

Once the new cloudlet is assigned a cloudlet ranking and the cloudlet lifetime has been calculated, the cloudlet manager may communicate with applications 332. Based on the cloudlet ranking and lifetime, cloudlet manager 324 may migrate and orchestrate 330 suitable workloads on the new cloudlet. For instance, cloudlet manager 324 may send commands 334A-B to applet 310A-B for orchestrating and scheduling workloads of applications 332 on the first and second computing devices 300A-B. In aspects, applications 332 may be located at the same or similar general location as the new cloudlet. In this way, applications 332 are able to utilize proximate storage and compute resources on new cloudlet, thereby reducing latencies associated with processing the workloads. Cloudlet manager 324 may comprise a scheduler to orchestrate 330 the workloads across the federated devices of the new cloudlet. Moreover, cloudlet manager may continue to monitor the performance of at least the first and second computing devices 300A-B of the new cloudlet based on continuous or periodic report 320A-B. If cloudlet manager 324 detects instability or failure of one or more of the federated devices, cloudlet manager 324 may determine whether to vacate the unstable device and/or to vacate the new cloudlet. If cloudlet manager 324 determines that the new cloudlet should be vacated, cloudlet manager 324 may determine whether one or more available nearby cloudlets exist. If so, cloudlet manager 324 may migrate the workloads of applications 332 to the one or more available nearby cloudlets (not shown). If not, cloudlet manager 324 may migrate the workloads of applications 332 to reserved resources 326 on public cloud infrastructure 322.

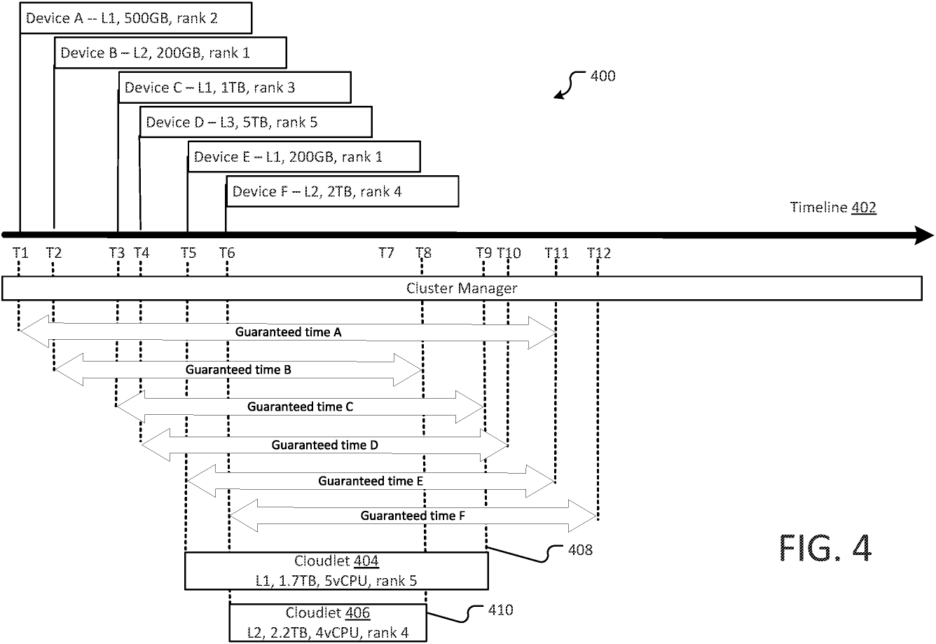

FIG. 4 shows a block diagram of an example timeline associated with dynamically creating and/or vacating on-demand datacenters, according to an example embodiment.

As illustrated, system 400 comprises timeline 402 associated with dynamically creating and/or vacating on-demand datacenters (or cloudlets), as illustrated by systems 200 and 300 (see e.g., FIGS. 2-3). As described above, when an applet is launched on a computing device (e.g., one of devices A-F), the applet may receive an amount of unused storage (e.g., a user-configurable amount or percentage of the unused storage) to be contributed. The applet may further determine a general location of the computing device. According to the illustrated example, device A may contribute 500 GB of storage and have a general location, L1; device B may contribute 200 GB of storage and have a general location, L2; device C may contribute 1 TB of storage and have a general location, L1; device D may contribute 5 TB of storage and have a general location, L3; device E may contribute 200 GB of storage and have a general location, L1; and device F may contribute 2 TB of storage and have a general location, L2.

The applet may then assess the computing device and assign a device ranking based on one or more of: available storage, processing unit speed, available processing cores and threads, random access memory (RAM), network stability, device type, device mobility, or the like. For instance, the computing device may be given a device ranking between “1” (lowest) to “5” (highest). According to the illustrated example, device A may be a tablet device assigned a device rank of “2”; device B may be a mobile device assigned a device rank of “1”; device C may be a laptop device assigned a device rank of “3”; device D may be a server device assigned a device rank of “5”; device E may be a mobile device assigned a device rank of “1”; and device F may be a personal gaming device assigned a device rank of “4.”

The applet may further receive a start time (e.g., the time when the computing device is registered) and a guaranteed time period of available resources from the computing device (e.g., devices A-F). In some cases, a minimum guaranteed time period is required by the system (e.g., 60 minutes, 90 minutes, 120 minutes, etc.). In aspects, the guaranteed time period of a computing device may comprise the minimum time period or a greater time period. According to the illustrated example, device A was registered at time T1 with a guaranteed time period A; device B was registered at time T2 with a guaranteed time period B; device C was registered at time T3 with a guaranteed time period C; device D was registered at time T4 with a guaranteed time period D; device E was registered at time T5 with a guaranteed time period E; and device F was registered at time T6 with a guaranteed time period E. In aspects, start times T1-T6 are sequential times on timeline 402, guaranteed time period A is greater than the minimum guaranteed time period, and guaranteed time periods B-F are the minimum guaranteed time period.

Among other things, the applet of each device A-F may report the contributed amount of storage, general location, start time, guaranteed time period, and device ranking to a cloudlet manager. The cloudlet manager may identify one or more registered computing devices that comply with one or more rules to form a cloudlet. For instance, the cloudlet manager may identify one or more registered computing devices in the same general location having at least one stationary computing device to federate into a cloudlet. In aspects, the cloudlet manager may federate devices to the cloudlet until additional rules are met, such as a minimum number of federated devices (e.g., 4 or 5) and/or a minimum amount of contributed resources.

According to the illustrated example, devices A, C, and E at location L1 may be federated as cloudlet 404 and devices B and F may be federated as cloudlet 406. For purposed of explanation, cloudlet 404 may comprise three (3) devices and cloudlet 406 may comprise two (2) devices; however, in examples, cloudlet 404 and cloudlet 406 may comprise additional devices (not shown) in compliance with one or more rules for a minimum number of devices and/or a minimum amount of contributed resources. Based on the number and rankings of the federated devices, the cloudlet manager may then calculate a cloudlet ranking from “1” (e.g., for a small-size cloudlet), which may be suitable for light-weight applications and workloads, to “10” (e.g., for a large-size cloudlet), which may be suitable for applications needing heavy processing and memory resources. According to the illustrated example, cloudlet 404 comprising devices A, C, and E, having combined storage of 1.7 TB, and supporting five (5) virtual CPUs may be assigned a cloudlet ranking of “5”; whereas cloudlet 406 comprising devices B and F, having combined storage of 2.2 TB, and supporting four (4) vCPUs may be assigned a ranking of “4.” Once a cloudlet is ranked, the cloudlet manager may schedule workloads of one or more applications in proximity to the general location of the cloudlet, thereby minimizing latencies associated with processing workloads of the one or more applications.

Additionally, based on start times and guaranteed availability periods of each federated device, the cloudlet manager may further calculate a cloudlet lifetime for cloudlets 404 and 406, which may depend on the start time of the last device added until the expiration time of the first guaranteed time period. According to the illustrated example, cloudlet 404 may have a cloudlet lifetime from T5 (the start time of the last federated device E) to T9 (the expiration of the guaranteed availability period C of the second federated device C). Note that guaranteed availability period A of the first federated device A is longer than the minimum guaranteed availability period and expires after the guaranteed availability period C of second federated device C. However, the cloudlet lifetime may expire when the first device expires (e.g., federated device C) at T9. In aspects, cloudlet 406 may have a cloudlet lifetime from T6 (the start time of the last federated device F) to T8 (the expiration of the first guaranteed availability period B of first federated device B). As should be appreciated, a cloudlet lifetime may be extended by federating one or more comparable devices to replace the one or more federated devices set to expire within a cloudlet. Otherwise, at the end of a cloudlet lifetime, the cloudlet manager may identify an available nearby cloudlet or reserved resources on a cloud datacenter for migrating workloads off the expiring cloudlet. It should be appreciated that cloudlets having a shorter lifetime may be suitable for processing simple, finite jobs; whereas cloudlets having a longer lifetime may be suitable for complex, multi-stage processing jobs.

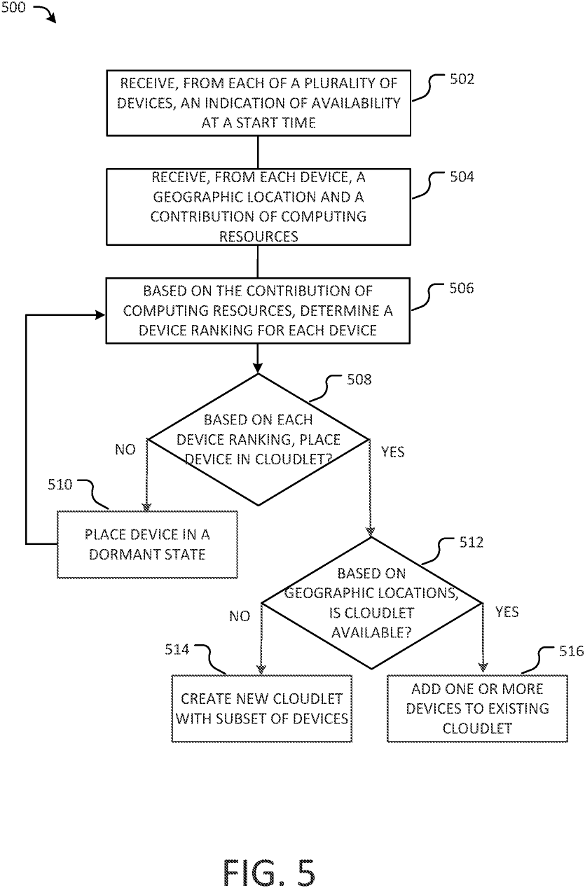

FIG. 5 shows a flowchart of an example method for dynamically creating proximate, on-demand datacenters, according to an example embodiment.

Technical processes shown in this figure will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance of the process to another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by an applet installed on a computing device and/or a cloudlet manager of a public cloud infrastructure, for instance.

Method 500 begins with operation 502. At operation 502, an indication of availability may be received at a start time from each of a plurality of computing devices. In aspects, the indication of availability may be received by a cloudlet manager in response to a communication from an applet installed on each computing device. For instance, when the applet registers the computing device, the indication of availability may be sent to the cloudlet manager.

At operation 504, a geographic location and a contribution of computing resources may be received for each of the plurality of computing devices. In aspects, the geographic location may be a general geographic area, which may not be a precise location, such as a GPS location, but a general vicinity such as a neighborhood (e.g., Jackson Heights), an area of a city (e.g., downtown, south suburban), an attraction (e.g., Fisherman’s Wharf, Disneyland®), and the like. The contribution of computing resources may correspond to a portion of unused resources (e.g., 10%-90%) of the computing device, which may include a percentage of available processing power and at least a minimum amount of available, unused storage (e.g., 1 GB, 10 GB, 50 GB, 100 GB, or the like). In aspects, the portion of unused resources may be user-configurable. In aspects, the geographic location and the contribution of computing resources may be received by the cloudlet manager in response to a communication from the applet installed on each computing device.

At operation 506, a device ranking for each device may be determined, where the device ranking may be based at least in part on the contribution of computing resources. For instance, the device ranking may be based on contributed computing resources such as available storage, processing unit speed, available processing cores and threads, random access memory (RAM), for instance. Additionally, the device ranking may be based on network stability, device type, device mobility, or the like. For example, the computing device may be given a device ranking between “1” (lowest) to “5” (highest).

At operation 508, based on each device ranking, it may be determined whether to place the computing device into a cloudlet (or datacenter). In examples, a cloudlet may serve as a proximate, on-demand datacenter for processing workloads, including combined storage, memory, and compute resources of a plurality of federated computing devices. Depending on the combination of federated devices, cloudlets may provide different levels of on-demand computing resources to a variety of applications. It may be determined to place the computing device into a cloudlet based on any number of conditions. For instance, the device ranking may be a “3” or a “4,” which may meet a threshold of computing resources for creating a cloudlet including the computing device. Alternatively, the device ranking may be a “1” and, based on the geographic location, the computing device may meet a rule (or condition) for a minimum number of devices of an existing cloudlet. Alternatively, the device ranking may be a “4” and the computing device may be a stationary device (e.g., personal computer, game console, or server), which may meet a rule (or condition) requiring at least one stationary device as an anchor for creating a cloudlet. If it is determined to create a cloudlet, the method may progress to operation 512. If it is determined not to place the computing device into a cloudlet, the method may progress to operation 510.

At operation 510, when it has been determined not to place at least one computing device into a cloudlet, the computing device may be placed in a dormant state. In this way, the computing device may be held for future addition to a cloudlet during a guaranteed availability period while saving battery life or other resources of the computing device. In some aspects, when the computing device is placed in a dormant state, the method may return to operation 506 and the device ranking may be re-calculated based on changing conditions, e.g., increased or decrease network stability, increased or decreased mobility, or the like. Moreover, the method may then return to operation 508 and, based on the re-calculated device ranking, it may be determined whether to place the computing device into a cloudlet.

At operation 512, when it has been determined to place the computing device into a cloudlet, based on the geographic area, it may be determined whether a cloudlet is available. When a cloudlet is not available at the geographic location, the method may progress to operation 514. When a cloudlet is available at the geographic location, the method may progress to operation 516.

At operation 514, a new cloudlet may be created by federating at least a subset of the plurality of computing devices. In some cases, the new cloudlet may be created with the subset of computing devices and subsequent computing devices may be added to (federated with) the subset of computing device in the new cloudlet. In aspects, when a new cloudlet is formed, on-demand computing resources may be provided in proximity to the geographic area, minimizing the latencies associated with remote workload processing.

At operation 516, one or more computing devices of the plurality of computing devices may be added to an existing cloudlet. In this case, the one or more computing devices may be federated with the other devices associated with the existing cloudlet. Similarly, when the one or more computing devices are added to an existing cloudlet, on-demand computing resources may be provided in proximity to the geographic area, minimizing the latencies associated with remote workload processing.

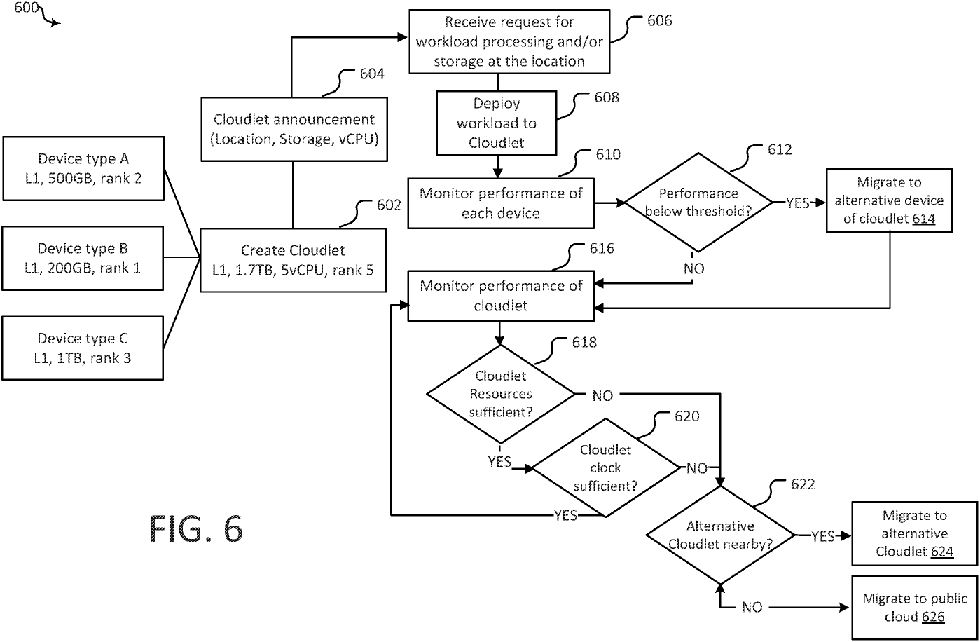

FIG. 6 shows a flowchart of an example method for orchestrating workloads on on-demand datacenters, according to an example embodiment.

Technical processes shown in this figure will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 6. Steps may be performed serially, in a partially overlapping manner, or fully in parallel. Thus, the order in which steps of method 600 are performed may vary from one performance of the process to another performance of the process. Steps may also be omitted, combined, renamed, regrouped, be performed on one or more machines, or otherwise depart from the illustrated flow, provided that the process performed is operable and conforms to at least one claim. The steps of FIG. 6 may be performed by an applet installed on a computing device and/or a cloudlet manager of a public cloud infrastructure, for instance.

Method 600 begins with operation 602. At operation 602, a cloudlet may be created by federating device type A, device type B, and device type C. In aspects, a cloudlet manager may create the cloudlet. As illustrated, device type A is located at general location L1, has 500 GB of contributed storage, and has been assigned a device rank of “2.” In aspects, device type A may be a laptop computer. Device type B is also located at general location L1, has 200 GB of contributed storage, and has been assigned a device rank of “1.” In aspects, device type B may be a mobile phone. Device type C is also located at general location L1, has 1 TB of contributed storage, and has been assigned a device rank of “3.” In aspects, device type C may be a personal computer. Upon federating device type A, device type B, and device type C, a cloudlet (or datacenter) may be created in proximity to general location L1, having 1.7 TB of combined storage and supporting five (5) vCPUs. Based on the combined resources associated with the cloudlet, a cloudlet ranking may be assigned. As illustrated, the cloudlet has been assigned a cloudlet ranking of “5.” In aspects, upon creating the cloudlet, the method may progress to operation 604 and/or operation 610.

At operation 604, a cloudlet announcement may be made. In some aspects, the cloudlet manager may broadcast the cloudlet announcement to one or more applications. For example, the cloudlet announcement may include the cloudlet location, amount of combined storage, the number of vCPUs supported by the cloudlet, and the cloudlet ranking.

At operation 606, in response to the cloudlet announcement, a request for workload processing and/or storage may be received by the cloudlet manager from one or more applications at the general location L1.

At operation 608, the workloads may be deployed to the cloudlet for processing. In aspects, deploying the workloads may comprise migrating one or more workloads from a public cloud datacenter onto the cloudlet for processing. For instance, a minimum processing power threshold may be calculated for each workload to complete a task without a failure. Then, the workload may be scheduled across a corresponding amount of shared storage, memory, and processing associated with the cloudlet, with each device receiving a chunk of the workload for processing. For instance, the cloudlet manager may employ a parallel processing model across the federated devices. In aspects, the cloudlet manager schedules each sequence or fragment of the workload across the federated devices, continuously tracks the sequences or fragments, and maintains a master list of the sequences or fragments across the federated devices. For example, the cloudlet manager acts as an “air-traffic controller” between federated devices of a cloudlet, where failure handling between the devices is similar to failure handling between virtual machines on server. As necessary, the cloudlet manager may reschedule and/or reallocate workloads or portions of workloads among the federated devices of the cloudlet.

At operation 610, performance of each device may be monitored. Monitoring the performance of each computing device of the federated subset of computing devices may include monitoring, for instance, the device ranking, device resource utilization, device processing speed, network stability, device mobility, and/or a remaining time of a guaranteed availability period.

At operation 612, it may be determined whether the performance of one or more devices falls below a threshold for processing the chunk of the workload assigned to the one or more devices for processing. If the performance of at least one computing device falls below the threshold, the method may progress to operation 614. If the performance of at least one computing device does not fall below the threshold, the method may progress to operation 616.

At operation 614, when the performance of at least one computing device (first device) falls below the threshold, the chunk (or portion) of the workload deployed to the first computing device may be migrated to another computing device (second device) of the cloudlet. For instance, unused computing resources of the second device may be evaluated to determine whether the unused computing resources are estimated to process the portion of the workload without a failure. If so, the portion of the deployed workload may be migrated to unused computing resources of the second computing device. If not, a subset of the portion of the deployed workload may be migrated to the unused computing resources of the second computing device, where the unused computing resources are estimated to process the subset of the portion of the workload without a failure. In this case, a remainder of the portion of the deployed workload may be migrated to at least one other computing device (e.g., a third computing device) of the cloudlet. Alternatively, if the unused computing resources of the second computing device are insufficient for processing a subset of the portion of the deployed workload, the portion of the deployed workload may be migrated to unused computing resources of one or more other computing devices, where the unused computing resources of the one or more other computing devices are estimated to process the portion of the workload without a failure.

At operation 616, a performance of the cloudlet may be monitored. In aspects, the cloudlet manager may perform constant performance monitoring and holds a state machine of each cloudlet. The performance monitoring may involve monitoring performance of each federated device of each cloudlet (including monitoring fluctuations in device rankings, monitoring device resource utilization, device stability, device processing speed, network stability, device mobility, and/or a remaining time of a guaranteed availability period); monitoring cloudlet remaining lifetime, performance, resource usage, power usage, etc.; monitoring progress of each fragment of each workload across the shared resources of each cloudlet; and the like.

As part of the monitoring, the cloudlet manager may continuously assess the resource utilization of the cloudlet. At operation 618, it may be determined whether the cloudlet comprises sufficient resources to process the assigned workloads. As detailed above, based on the cloudlet ranking, the cloudlet manager may assign workloads to the cloudlet that are estimated to be processed without failure. However, in some cases, whether due to device failures or other changes in conditions, the cloudlet resources may become insufficient to process the assigned workloads. If it is determined that the cloudlet comprises sufficient resources to process the assigned workloads, the method may progress to operation 620. If it is determined that the cloudlet comprises insufficient resources to process the assigned workloads, the method may progress to operation 622.

When it is determined that the cloudlet comprises sufficient resources to process the assigned workloads, at operation 620, it may be determined whether the remaining cloudlet lifetime is sufficient to complete the assigned workloads. As detailed above, the cloudlet manager may assign workloads to the cloudlet that are estimated to be completed within the cloudlet lifetime. However, in some cases, whether due to device failures, network failures or other latency-causing events, the remaining cloudlet lifetime may be insufficient to complete the assigned workloads. If it is determined that the remaining cloudlet lifetime is sufficient to complete the assigned workloads, the method may return to operation 616 for continued performance monitoring of the cloudlet. If it is determined that the remaining cloudlet lifetime is insufficient to complete the assigned workloads, the method may progress to operation 622.

When it is determined that the cloudlet comprises insufficient resources to process the assigned workloads, or that the remaining cloudlet lifetime is insufficient to complete the assigned workloads, at operation 622, it may be determined whether one or more alternative nearby cloudlets are available. In aspects, a nearby cloudlet may be “available” when the nearby cloudlet is estimated to comprises sufficient unused resources to process at least a portion of the workloads without a failure. If it is determined that one or more alternative nearby cloudlets are available, the method may progress to operation 624. If it is determined that one or more alternative nearby cloudlets are not available, the method may progress to operation 626.

When it is determined that one or more alternative nearby cloudlets are available, at operation 624, the assigned workloads of the cloudlet may be migrated to the one or more available nearby cloudlets for processing. As detailed above, a minimum processing power threshold may be calculated for each workload to complete the task without a failure. In some cases, a single nearby cloudlet may not have sufficient resources to process all of the workloads assigned to the cloudlet. If not, the assigned workloads may be scheduled across different nearby cloudlets. In this case, the cloudlet manager may reschedule each sequence or fragment of each assigned workload across the federated devices of the one or more nearby cloudlets. Similar to the example above, the cloudlet manager acts as an “air-traffic controller” between nearby cloudlets, where failure handling between cloudlets is similar to failure handling between virtual machines of different servers. As necessary, the cloudlet manager may reschedule and/or reallocate workloads or portions of workloads among the federated devices of the one or more nearby cloudlets.

When it is determined that one or more alternative nearby cloudlets are not available, at operation 626, the assigned workloads of the cloudlet may be migrated to a datacenter on the public cloud network. For instance, the assigned workloads may be migrated to reserved resources on a near- or far-edge datacenter. Reserving resources on the cloud for failovers enables the cloudlet manager to seamlessly migrate the assigned workloads to the cloud. While near- or far-edge datacenters may be a greater distance away from the general location, a minimal increase in latency may be preferable to a failure. Moreover, the method may return to operation 622 to continue searching for one or more nearby cloudlets. When one or more nearby cloudlets are identified, the method may progress to operation 624 and the assigned workloads may be migrated from the cloud datacenter onto the one or more nearby cloudlets.

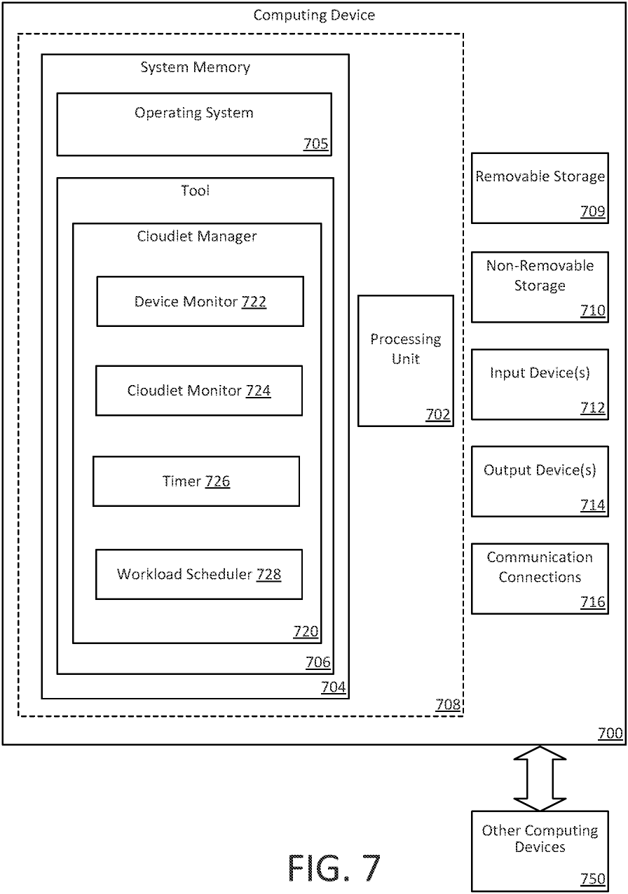

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program tools 706 suitable for performing the various aspects disclosed herein such. The operating system 705, for example, may be suitable for controlling the operation of the computing device 700. Furthermore, aspects of the disclosure may be practiced in conjunction with a graphics library, other operating systems, or any other application programs and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program tools 706 and data files may be stored in the system memory 704. While executing on the at least one processing unit 702, the program tools 706 (e.g., cloudlet manager 720) may perform processes including, but not limited to, the aspects, as described herein. The cloudlet manager 720 includes a device monitor 722, a cloudlet monitor 724, a timer 726, and a workload scheduler 728, as described in more detail above.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712, such as a keyboard, a mouse, a pen, a sound or voice input device, a touch or swipe input device, etc. The output device(s) 714 such as a display, speakers, a printer, etc., may also be included. The aforementioned devices are examples and others may be used. The computing device 700 may include one or more communication connections 716 allowing communications with other computing devices 750. Examples of the communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. In aspects, computer storage media is non-transitory and does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

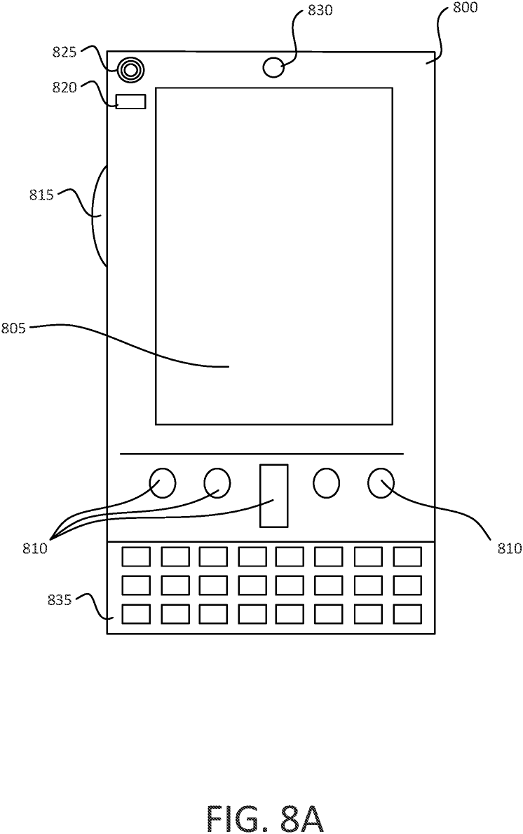

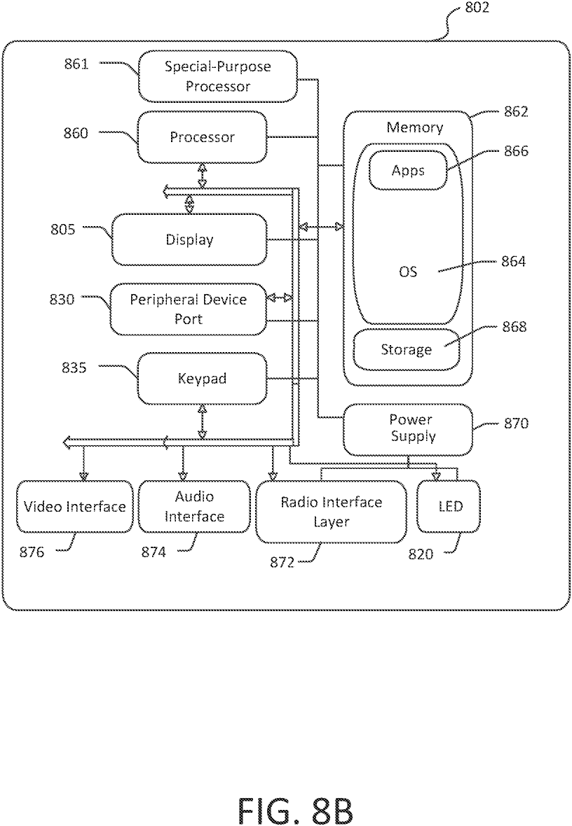

FIGS. 8A and 8B illustrate a computing device 800 or mobile computing device 800, for example, a mobile telephone, a smart phone, wearable computer (such as a smart watch), a tablet computer, a laptop computer, a server, and the like, with which aspects of the disclosure may be practiced. In some aspects, the client (e.g., subscribing device as detailed in FIG. 3) utilized by a user may be a mobile computing device. With reference to FIG. 8A, one aspect of a computing device 800 for implementing the aspects is illustrated. In a basic configuration, the computing device 800 is a handheld computer having both input elements and output elements. The computing device 800 typically includes a display 805 and one or more input buttons 810 that allow the user to enter information into the computing device 800. The display 805 of the computing device 800 may also function as an input device (e.g., a touch screen display). If included as an optional input element, a side input element 815 allows further user input. The side input element 815 may be a rotary switch, a button, or any other type of manual input element. In alternative aspects, computing device 800 may incorporate more or fewer input elements. For example, the display 805 may not be a touch screen in some aspects. In yet another alternative aspect, the computing device 800 is a portable phone system, such as a cellular phone. The computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some aspects, the computing device 800 incorporates a vibration transducer for providing the user with tactile feedback. In yet another aspect, the computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a computing device, a server (e.g., a public cloud server executing a cloudlet manager), a mobile computing device (e.g., a subscribing device executing an applet), etc. That is, the computing device 800 can incorporate a system 802 (e.g., a system architecture) to implement some aspects. The system 802 can implemented as a “smart phone” capable of running one or more applications (e.g., an applet). In some aspects, the system 802 is integrated as a computing device, such as an integrated digital assistant (PDA) and wireless phone.

One or more application programs 866 may be loaded into the memory 862 and run on or in association with the operating system 864. Examples of the application programs 866 include a cloudlet manager, an applet, a scheduler, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as monitored data (e.g., device, network, and cloudlet data), a master workload list, workload output and input, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the computing device 800 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 (e.g., LED) may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A computing device 800 implementing the system 802 may have additional features or functionality. For example, the computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the computing device 800 and stored via the system 802 may be stored locally on the computing device 800, as described above, or the data may be stored on any number of storage media that may be accessed by the device via the radio interface layer 872 or via a wired connection between the computing device 800 and a separate computing device associated with the computing device 800, for example, a server computer in a distributed computing network, such as the Internet. As should be appreciated such data/information may be accessed via the computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In aspects, a method of a method for dynamically creating a datacenter in geographic proximity to one or more applications is provided. The method includes receiving an indication of a contribution of computing resources from each of a plurality of computing devices in proximity to a geographic area and, based on the contribution of computing resources, the method further includes determining a device ranking for each computing device of the plurality of computing devices. Based on the device ranking for each computing device, the method also includes determining that a subset of the plurality of computing devices meets at least one condition for dynamically creating the datacenter in proximity to the geographic area. Additionally, the method includes federating the subset of computing devices to dynamically create the datacenter in proximity to the geographic area, where the datacenter includes shared computing resources of the federated subset of computing devices. Further, based on the device rankings of the federated subset of computing devices, the method includes assigning a datacenter ranking to the datacenter and, based on the datacenter ranking, deploying one or more workloads of the one or more applications onto the shared computing resources of the datacenter.

Further to the aspects, the method includes monitoring a performance of each computing device of the federated subset of computing devices and, in response to determining that a first performance of a first computing device is insufficient to process at least a portion of a deployed workload, automatically migrating the at least one portion of the deployed workload to a second computing device of the federated subset of computing devices. Additionally or alternatively, the method includes monitoring a performance of the datacenter and, in response to determining that the datacenter performance is insufficient to process the one or more deployed workloads, determining whether one or more datacenters are available in proximity to the geographic area. Additionally or alternatively, when one or more datacenters are available in proximity to the geographic area, the method includes evaluating unused shared resources of each of the one or more available datacenters, identifying at least one available datacenter having unused shared resources estimated to process at least a portion of the deployed one or more workloads without a failure, and automatically migrating at least the portion of the deployed one or more workloads to the unused shared resources of the at least one available datacenter in proximity to the geographic area. Additionally or alternatively, when one or more datacenters are not available in proximity to the geographic area, the method includes automatically migrating the deployed one or more workloads to a public cloud datacenter and in some aspects, where the deployed one or more workloads are automatically migrated to reserved resources on the public cloud datacenter. In some aspects, the indication of computing resources includes one or more of: an amount of available processing power, an amount of available memory, an amount of available storage, and a guaranteed availability period. In some aspects, at least one of the amount of available processing power, the amount of available memory, the amount of available storage, or the guaranteed availability period is configurable. In some aspects, the indication of computing resources is received continuously or periodically. In some aspects, the indication of computing resources is received from an application associated with each computing device of the plurality of computing devices. In some aspects, monitoring the performance of each computing device of the federated subset of computing devices includes monitoring one or more of: the device ranking, device resource utilization, device processing speed, network stability, device mobility, or a remaining time of a guaranteed availability period.

In other aspects, a system for dynamically creating a cloudlet in geographic proximity to one or more applications is provided. The system includes computer-executable instructions that when executed by a processor cause the system to perform operations. The operations include receiving an indication of a contribution of computing resources from each of a plurality of computing devices in proximity to a geographic area and, based on the contribution of computing resources, determining a device ranking for each computing device of the plurality of computing devices. Based on the device ranking of each computing device, the operations further include determining that a subset of the plurality of computing devices meets at least one condition for dynamically creating the cloudlet in proximity to the geographic area, where the cloudlet is a proximate datacenter to the geographic area. Additionally, the operations include federating the subset of computing devices to dynamically create the cloudlet in proximity to the geographic area, where the cloudlet includes shared computing resources of the federated subset of computing devices. Based on the device rankings of the federated subset of computing devices, the operations include assigning a cloudlet ranking to the cloudlet and, based on the cloudlet ranking, deploying one or more workloads of the one or more applications onto the shared computing resources of the cloudlet. Further, the operations include monitoring a performance of each computing device of the federated subset of computing devices and, in response to determining that a first performance of a first computing device of the federated subset of computing devices falls below a threshold, the operations include automatically migrating at least a portion of the one or more deployed workloads onto unused computing resources of a second computing device of the federated subset of computing devices.

Further to the other aspects, the computer-executable instructions when executed by the processor causing the system to perform further operations. The further operations include monitoring a performance of the cloudlet and, in response to determining that the cloudlet performance is insufficient to process the one or more deployed workloads, determining whether one or more cloudlets are available in proximity to the geographic area. Additionally or alternatively, when one or more cloudlets are available in proximity to the geographic area, the further operations include evaluating unused shared resources of each of the one or more available cloudlets, identifying at least one available cloudlet having unused shared resources estimated to process the one or more deployed workloads without a failure, and automatically migrating the one or more deployed workloads to the unused shared resources of the at least one available cloudlet in proximity to the geographic area. Additionally or alternatively, when one or more cloudlets are not available in proximity to the geographic area, the further operations include automatically migrating the one or more deployed workloads to a public cloud datacenter. In some aspects, monitoring the performance of each computing device of the federated subset of computing devices comprises monitoring one or more of: the device ranking, device resource utilization, device processing speed, network stability, device mobility, or a remaining time of a guaranteed availability period.

In yet other aspects, a system for dynamically creating a datacenter in geographic proximity to one or more applications is provided. The system includes computer-executable instructions that when executed by a processor cause the system to perform operations. The operations include receiving an indication of a contribution of computing resources from each of a plurality of computing devices in proximity to a geographic area and, based on the contribution of computing resources, determining a device ranking for each computing device of the plurality of computing devices. Based on the device ranking for each computing device, the operations include determining that a subset of the plurality of computing devices meets at least one condition for dynamically creating the datacenter in proximity to the geographic area. Additionally, the operations include federating the subset of computing devices to dynamically create the datacenter in proximity to the geographic area, where the datacenter comprises shared computing resources of the federated subset of computing devices. Based on the device rankings of the federated subset of computing devices, the operations include assigning a datacenter ranking to the datacenter and, based on the datacenter ranking, deploying one or more workloads of the one or more applications onto the shared computing resources of the datacenter. Further, the operations include monitoring a performance of the datacenter. In response to determining that the datacenter performance is insufficient to process the one or more deployed workloads, the operations include determining that at least one datacenter is available in proximity to the geographic area and automatically migrating the one or more deployed workloads to the at least one available datacenter in proximity to the geographic area.

Further to the yet other aspects, the computer-executable instructions when executed by the processor cause the system to perform further operations. The further operations include evaluating unused shared resources of the at least one available datacenter, estimating that the unused shared resources are sufficient to process the one or more deployed workloads without a failure, and automatically migrating the one or more deployed workloads to the unused shared resources of the at least one available datacenter in proximity to the geographic area. Additionally or alternatively, the further operations include monitoring a performance of each computing device of the federated subset of computing devices and, in response to determining that a first performance of a first computing device of the federated subset of computing devices is insufficient to process at least a portion of a deployed workload, automatically migrating the at least one portion of the deployed workload to a second computing device of the federated subset of computing devices. In some aspects, monitoring the performance of each computing device of the federated subset of computing devices includes monitoring one or more of: the device ranking, device resource utilization, device processing speed, network stability, device mobility, or a remaining time of a guaranteed availability period.

Any of the one or more above aspects in combination with any other of the one or more aspects. Any of the one or more aspects as described herein.

What is claimed is:

1. A method of dynamically creating a datacenter in geographic proximity to one or more applications, the method comprising:
receiving an indication of a contribution of computing resources from each of a plurality of computing devices in proximity to a geographic area;
based on the contribution of computing resources, determining a device ranking for each computing device of the plurality of computing devices;
based on the device ranking of each computing device, determining that a subset of the plurality of computing devices meets at least one condition for dynamically creating the datacenter in proximity to the geographic area;
federating the subset of computing devices to dynamically create the datacenter in proximity to the geographic area, wherein the datacenter comprises shared computing resources of the federated subset of computing devices;
based on the device rankings of the federated subset of computing devices, assigning a datacenter ranking to the datacenter; and
based on the datacenter ranking, deploying one or more workloads of the one or more applications onto the shared computing resources of the datacenter.

2. The method of claim 1, further comprising:
monitoring a performance of each computing device of the federated subset of computing devices; and
in response to determining that a first performance of a first computing device is insufficient to process at least a portion of a deployed workload, automatically migrating the at least one portion of the deployed workload to a second computing device of the federated subset of computing devices.

3. The method of claim 1, further comprising:
monitoring a performance of the datacenter; and
in response to determining that the datacenter performance is insufficient to process the one or more deployed workloads, determining whether one or more datacenters are available in proximity to the geographic area.

4. The method of claim 3, further comprising:
when one or more datacenters are available in proximity to the geographic area, evaluating unused shared resources of each of the one or more available datacenters;
identifying at least one available datacenter having unused shared resources estimated to process at least a portion of the deployed one or more workloads without a failure; and
automatically migrating at least the portion of the deployed one or more workloads to the unused shared resources of the at least one available datacenter in proximity to the geographic area.

5. The method of claim 3, further comprising:
when one or more datacenters are not available in proximity to the geographic area, automatically migrating the deployed one or more workloads to a public cloud datacenter.

6. The method of claim 5, wherein the deployed one or more workloads are automatically migrated to reserved resources on the public cloud datacenter.

7. The method of claim 1, wherein the indication of computing resources includes one or more of: an amount of available processing power, an amount of available memory, an amount of available storage, and a guaranteed availability period.

8. The method of claim 7, wherein at least one of the amount of available processing power, the amount of available memory, the amount of available storage, or the guaranteed availability period is configurable.

9. The method of claim 1, wherein the indication of computing resources is received continuously or periodically.

10. The method of claim 1, wherein the indication of computing resources is received from an application associated with each computing device of the plurality of computing devices.

11. The method of claim 2, wherein monitoring the performance of each computing device of the federated subset of computing devices comprises monitoring one or more of: the device ranking, device resource utilization, device processing speed, network stability, device mobility, or a remaining time of a guaranteed availability period.

12. A system for dynamically creating a cloudlet in geographic proximity to one or more applications, the system comprising computer-executable instructions that when executed by a processor cause the system to perform operations, comprising:
receiving an indication of a contribution of computing resources from each of a plurality of computing devices in proximity to a geographic area;
based on the contribution of computing resources, determining a device ranking for each computing device of the plurality of computing devices;
based on the device ranking of each computing device, determining that a subset of the plurality of computing devices meets at least one condition for dynamically creating the cloudlet in proximity to the geographic area, wherein the cloudlet is a proximate datacenter to the geographic area;
federating the subset of computing devices to dynamically create the cloudlet in proximity to the geographic area, wherein the cloudlet comprises shared computing resources of the federated subset of computing devices;
based on the device rankings of the federated subset of computing devices, assigning a cloudlet ranking to the cloudlet;
based on the cloudlet ranking, deploying one or more workloads of the one or more applications onto the shared computing resources of the cloudlet;
monitoring a performance of each computing device of the federated subset of computing devices; and
in response to determining that a first performance of a first computing device of the federated subset of computing devices falls below a threshold, automatically migrating at least a portion of the one or more deployed workloads onto unused computing resources of a second computing device of the federated subset of computing devices.

13. The system of claim 12, the computer-executable instructions when executed by the processor causing the system to perform further operations, comprising:
monitoring a performance of the cloudlet; and
in response to determining that the cloudlet performance is insufficient to process the one or more deployed workloads, determining whether one or more cloudlets are available in proximity to the geographic area.

14. The system of claim 13, the computer-executable instructions when executed by the processor causing the system to perform further operations, comprising:
when one or more cloudlets are available in proximity to the geographic area, evaluating unused shared resources of each of the one or more available cloudlets;
identifying at least one available cloudlet having unused shared resources estimated to process the one or more deployed workloads without a failure; and
automatically migrating the one or more deployed workloads to the unused shared resources of the at least one available cloudlet in proximity to the geographic area.

15. The system of claim 13, the computer-executable instructions when executed by the processor causing the system to perform further operations, comprising:
when one or more cloudlets are not available in proximity to the geographic area, automatically migrating the one or more deployed workloads to a public cloud datacenter.

16. The system of claim 12, wherein monitoring the performance of each computing device of the federated subset of computing devices comprises monitoring one or more of: the device ranking, device resource utilization, device processing speed, network stability, device mobility, or a remaining time of a guaranteed availability period.

17. A system for dynamically creating a datacenter in geographic proximity to one or more applications, the system comprising computer-executable instructions that when executed by a processor cause the system to perform operations, comprising:
receiving an indication of a contribution of computing resources from each of a plurality of computing devices in proximity to a geographic area;
based on the contribution of computing resources, determining a device ranking for each computing device of the plurality of computing devices;
based on the device ranking for each computing device, determining that a subset of the plurality of computing devices meets at least one condition for dynamically creating the datacenter in proximity to the geographic area;
federating the subset of computing devices to dynamically create the datacenter in proximity to the geographic area, wherein the datacenter comprises shared computing resources of the federated subset of computing devices;
based on the device rankings of the federated subset of computing devices, assigning a datacenter ranking to the datacenter;
based on the datacenter ranking, deploying one or more workloads of the one or more applications onto the shared computing resources of the datacenter;
monitoring a performance of the datacenter;
in response to determining that the datacenter performance is insufficient to process the one or more deployed workloads, determining that at least one datacenter is available in proximity to the geographic area; and
automatically migrating the one or more deployed workloads to the at least one available datacenter in proximity to the geographic area.

18. The system of claim 17, the computer-executable instructions when executed by the processor causing the system to perform further operations, comprising:
evaluating unused shared resources of the at least one available datacenter;
estimating that the unused shared resources are sufficient to process the one or more deployed workloads without a failure; and
automatically migrating the one or more deployed workloads to the unused shared resources of the at least one available datacenter in proximity to the geographic area.

19. The system of claim 17, the computer-executable instructions when executed by the processor causing the system to perform further operations, comprising:
monitoring a performance of each computing device of the federated subset of computing devices; and
in response to determining that a first performance of a first computing device of the federated subset of computing devices is insufficient to process at least a portion of a deployed workload, automatically migrating the at least one portion of the deployed workload to a second computing device of the federated subset of computing devices.

20. The system of claim 19, wherein monitoring the performance of each computing device of the federated subset of computing devices comprises monitoring one or more of: the device ranking, device resource utilization, device processing speed, network stability, device mobility, or a remaining time of a guaranteed availability period.
